(19) United States
(12) Patent Application Publication
(10) Pub. No.: US 2025/0045823 A1
(43) Pub. Date: Feb. 6, 2025

(54) Generating Synthetic Data For Machine Learning Training

(71) Applicant: Data-Core Systems, Inc., Bristol, PA (US)

(72) Inventors: Himadri Mukherjee, Kolkata (IN); Soumak Chakraborty, Konnagar (IN); Chandan Ramani, Bolpur (IN); Alo Ghosh, Menlo Park, CA (US)

(21) Appl. No.: 18/675,228

(22) Filed: May 28, 2024

(30) Foreign Application Priority Data
Aug. 3, 2023 (IN) 202311052251

(51) Int. Cl. G06Q 40/04; G06N 20/00

(52) U.S. Cl. CPC G06Q 40/04; G06N 20/00

(57) ABSTRACT

Disclosed embodiments include using actual data to generate synthetic data that is used for training machine learning models. Some embodiments include receiving an actual dataset comprising a time-ordered sequence of historical data, and based on the actual dataset, generating one or more synthetic datasets during the timeframe. Embodiments further include training a machine learning model with data comprising the actual dataset and the one or more synthetic datasets. After training the machine learning model, some embodiments include using the machine learning model to forecast a future data based on the historical data and the synthetic data.

### CROSS REFERENCE TO RELATED APPLICATIONS

This application claims priority to Indian Provisional Patent Application No. 202311052251 titled “Momentum Trading Using Deep Reinforcement Learning Comprising Synthetic Peer Generation Techniques for Stock Price Forecasting,” filed on Aug. 3, 2023, and currently pending. The entire contents of Indian Provisional Application No. 202311052251 are incorporated herein by reference.

### SUMMARY

The stock market can be very volatile. Prices of stocks tend to change asynchronously throughout the day. Investing in stocks both in the long term and short term can be very profitable if the investment timeline (buying and selling point) is properly chosen. However, investing in the stock market can be risky because of the underlying unpredictability of future prices. Nevertheless, price forecasting systems can provide insight into potential future prices so that investors can plan investments accordingly.

Automatic stock price forecasting systems can be very useful. Many different stocks can be traded in the public markets and their prices change second to second. One of the major challenges in training automatic forecasting systems is the unavailability of adequate training data both in terms of the volume of data available and the variety of data available. Disclosed embodiments present a technique sometimes referred to herein as EchoFlux that generates synthetic data for training the systems.

Experimental results described herein show that price prediction models that have been trained with synthetic data generated by the disclosed EchoFlux techniques perform better (i.e., make more accurate future predictions) than prediction models that have been trained with only actual historical data. Further, the experimental results show that training price prediction models with synthetic data generated by the disclosed EchoFlux techniques requires less training data than traditional approaches that use only actual historical data. Since models can be trained with less data, computing systems that implement price forecasting models training according to the disclosed EchoFlux techniques require less memory resources and require less training time (i.e., fewer processing cycles) as compared to computing systems that implement price forecasting models trained with traditional approaches. Thus, aspects of the disclosed EchoFlux techniques improve the technical operation of computing systems configured to implement price forecasting models as compared to traditional methods.

In operation, the EchoFlux techniques include generating synthetic peer stocks that move in tandem with the original stock (Echo) but are also different from the original stock in terms of variance (Flux). The synthetic data generated by the EchoFlux techniques provides a more robust dataset for training a Machine Learning-based stock price forecasting system by combining synthetic data for one or more synthetic peer stocks along with the original data for an actual stock. As mentioned earlier and described further herein, stock price forecasting models trained using the synthetic peers (and their corresponding synthetic data) have been found to be more accurate in terms of average deviation from actual prices than traditional approached that use only actual historical data for model training.

There have been several attempts at forecasting stock prices, most of them targeted towards the end of day closing price. Examples of earlier attempts include those described in: (i) Staffini, A., Stock price forecasting by a deep convolutional generative adversarial network, Frontiers in Artificial Intelligence, 5, 837596 (2022); (ii) Vijh, M., Chandola, D., Tikkiwal, V. A., & Kumar, A., Stock closing price prediction using machine learning techniques, Procedia computer science, 167, 599-606 (2020); (iii) Pratheeth, S., & Prasad, V., Stock Price Prediction using Machine Learning and Deep Learning, 2021 IEEE Mysore Sub Section International Conference (MysuruCon), pp. 660-664 (October 2021); (iv) Varaprasad, B. N., Kanth, C. K., Jeevan, G., & Chakravarti, Y. K., Stock Price Prediction using Machine Learning, 2022 International Conference on Electronics and Renewable Systems (ICEARS), pp. 1309-1313 (2022); and (v) Shen, J., & Shafiq, M. O., Short-term stock market price trend prediction using a comprehensive deep learning system, Journal of Big Data, 7(1), pp. 1-33 (2020).

But none of these prior approaches has had significant success. Forecasting closing prices of stocks on a daily level is itself a difficult task and the difficulty is further magnified when quarterly data is used. One of the major reasons for this difficulty is the unavailability of data especially for stocks which have gone public recently because stocks that have only recently become publicly traded generally have less historical price data available for analysis as compared to other more established companies with many years of stock price history. There are many new stocks which demonstrate high volatility like older stocks but training automatic forecasting systems for them is difficult due to unavailability of data (short historical price data).

Newer data is also very important for understanding the price movement of stocks (irrespective of the time when the stock became publicly traded) as all stocks (both newly-listed stocks and well-established stocks) are influenced by recent factors and often indicate the nature of price movement of a stock. In the case of forecasting quarterly stock prices using quarterly information, the number of available data points for training the systems is greatly reduced thereby making training more difficult.

To tackle this paucity of historical price data, different data augmentation schemes have been proposed. Examples of data augmentation schemes include those disclosed in: (i) Teng, X., Wang, T., Zhang, X., Lan, L., & Luo, Z., Enhancing stock price trend prediction via a time-sensitive data augmentation method, Complexity, pp. 1-8 (2020); and (ii) Yadav Vanguri, N., Pazhanirajan, S., & Anil Kumar, T., Extraction of Technical Indicators and Data Augmentation-Based Stock Market Prediction Using Deep LSTM Integrated Competitive Swarm Feedback Algorithm, International Journal of Information Technology & Decision Making, pp. 1-27 (2023).

But these prior approaches do not consider the concept of integrating a stock's original information along with peer stocks. There are various attributes like belongingness to the same industry or sector, having similar market capitalization, similar price movement, etc. that can be considered for associating a stock as peer of another stock.

However, associating stocks as peers based on price movement is very difficult as different stocks often demonstrate very little correlation in terms of price movement. Price based peering, if it can be done, can enhance the effectiveness of forecasting systems by introducing another dimension of variability. Price-based peering can also help supplement for the unavailability of data.

Creating a synthetic peer of a particular stock involves generating a synthetic market data series that closely mirrors the pattern of real price sequences. One classical approach to the problem is to create a Vector Autoregression Model as described in Lütkepohl, H., Vector autoregressive models, Handbook of research methods and applications in empirical macroeconomics, p. 30 (2013). In Lütkepohl, lagged values of the Open, High, Low and Close prices are used to predict the current values. Another approach favored by some researchers is to stitch together sub-samples of the real data series in a varying time-order as described in Kinlay, J., Synthetic Market Data and Its Applications (2023), available at SSRN 4380552. But while these approaches have been used in connection with forecasting stock prices, these techniques have not been used for generating synthetic stock price data that is used for training machine learning models to forecast stock prices in the manner described herein.

Embodiments disclosed herein include developing synthetic peers of a particular stock using the novel EchoFlux techniques. The EchoFlux techniques include statistical approaches that treat synthetic price data of a stock as an “echo” of its original counterpart having a “flux” component that makes the synthetic price data different from the original stock price data. One important aspect of the technique is generating synthetic peer stocks that move in tandem with the original stock thereby making available a bigger and more robust dataset for training machine learning models by combining multiple peers with the original data. The stock price forecasting models trained using the synthetic peer data generated according to the disclosed approaches have been found to be more accurate in terms of average deviation from actual price.

In some embodiments, the EchoFlux technique includes generating a pool of synthetic peer stocks P₁ . . . P_{N} based on the data of an original stock S. The synthetic peers adhere to the nature of price movement of S and at the same time introduce variability. This allows for forecasting stock prices with lower error.

A stock's data (e.g., daily prices or other data) can be represented as an ordered sequence of m points [s₁, s₂, . . . , sₘ], where every sₘ represents the stock's price on the m^{th} day. This technique is able to generate multiple peer sequences each of which has m points. The proposed bi-stage transformation of sᵢ to pᵢ is presented as follows:
pᵢ=(sᵢ θᵢ) ψᵢsᵢ, where: pᵢ represents the i^{th} sample of the peer stock P, generated from the i^{th} sample of the original stock S;
θᵢ represents the maximum deviation percentage (magnitude) of pᵢ from sᵢ; and
ψᵢ represents the associativity of θᵢ with sᵢ.

In operation, 0≤θᵢ≤L, where θᵢ∈R. ψᵢ∈[+, −], and where L denotes the maximum deviation. Thus if ψᵢ=+, then ∀p,s: p≥s. Similarly, if ψᵢ=−, then ∀p,s: p≤s. A higher value of L allows higher deviation of peers from the original data. Using the ψ values, peers ψ_{vq} are generated where v∈{{+}, {−}, {+, −}}, q∈R and |q| represents the number of peer stocks.

In some embodiments, to determine an acceptably representative peer group for a stock S_{T}, q peers ∀ v are generated leading to 3*q peers. For example, 15 peers would be generated when q=5 and where each set of peers includes (i) a first peer where the synthetic price for the first peer at point m is less than the actual price of the actual stock at sₘ (see, e.g., FIGS. 1-2). (ii) a second peer where the synthetic price for the second peer at point m is greater than the actual price of the actual at sₘ (see, e.g., FIGS. 3-4); and (iii) a third peer where the synthetic price for the third peer at point m is greater than or less than the actual price of the actual stock at sₘ (see, e.g., FIGS. 5-6). Unordered combinations of the 3*q peers along with the original data are tested to determine an acceptably representative peer combination to enhance forecast performance. The associated figures along with the used methodology are described herein.

Certain examples described herein may include none, some, or all of the above described features and/or advantages. Further, additional features and/or advantages may be readily apparent to persons of ordinary skill in the art based on reading the figures, descriptions, and claims included herein.

### BRIEF DESCRIPTION OF THE DRAWINGS

For a more complete understanding of the present disclosure and its features and advantages, reference is now made to the following description, taken in conjunction with the accompanying drawings.

FIG. 1 shows an example method for generating synthetic stock price data for a synthetic stock based on actual stock price data for an original stock where the synthetic stock prices in the synthetic stock price data is always less than the original stock prices in the original stock price data according to some embodiments.

FIG. 2 shows a chart depicting prices of an original stock compared to synthetically generated prices of a synthetic peer created by the method shown in FIG. 1 according to some embodiments.

FIG. 3 shows an example method for generating synthetic stock price data for a synthetic stock based on actual stock price data for an original stock where the synthetic stock prices in the synthetic stock price data is always greater than the original stock prices in the original stock price data according to some embodiments.

FIG. 4 shows a chart depicting prices of an original stock compared to synthetically generated prices of a synthetic peer created by the method shown in FIG. 3 according to some embodiments.

FIG. 5 shows an example method for generating synthetic stock price data for a synthetic stock based on actual stock price data for an original stock where the synthetic stock prices in the synthetic stock price data are both (i) less than the original stock prices in the original stock price data and (ii) greater than the original stock prices in the original stock price data, according to some embodiments.

FIG. 6 shows a chart depicting prices of an original stock compared to synthetically generated prices of a synthetic peer created by the method shown in FIG. 5 according to some embodiments.

FIG. 7 shows an example method for merging original stock data with synthetically generated stock data according to some embodiments.

FIG. 8 shows a chart depicting prices of an original stock compared to synthetically generated prices of a synthetic peer created by the method shown in FIG. 5 showing positive and negative deviations in the synthetic peer relative to the original stock according to some embodiments.

FIG. 9A shows an example method for generating synthetic data for machine learning according to some embodiments.

FIG. 9B shows additional aspects of the method of FIG. 9A for generating synthetic data for machine learning according to some embodiments.

FIG. 10 shows an example computing system configured for implementing aspects of the methods and processes disclosed herein.

### DETAILED DESCRIPTION OF THE FIGURES

Disclosed embodiments include, among other features, generating synthetic peer stock price data with respect to input stock price data. The disclosed embodiments, and aspects thereof, are sometimes referred to as the “EchoFlux.” In operation, the disclosed techniques include generating synthetic peer stocks (with corresponding peer stock data) that moves in tandem with the original stock (Echo), but the synthetic peer stocks (and their corresponding data) are different from the original stock by a variance (Flux). Compared with traditional approaches, generating peer stock data results in a better dataset for training a Machine Learning-based stock price forecasting system by combining multiple peers along with the original data.

Disclosed embodiments of the EchoFlux process can generate 3 types of synthetic stock data based on original stock data, including: (1) generating synthetic stock price data for a synthetic stock based on actual stock price data for an original stock where the synthetic stock prices in the synthetic stock price data are always lower than the original stock prices in the original stock price data; (2) generating synthetic stock price data for a synthetic stock based on actual stock price data for an original stock where the synthetic stock prices in the synthetic stock price data are always greater than the original stock prices in the original stock price data; and (3) generating synthetic stock price data for a synthetic stock based on actual stock price data for an original stock where the synthetic stock prices in the synthetic stock price data are both (a) greater than the original stock prices in the original stock price data and (b) less than the original stock prices in the original stock price data.

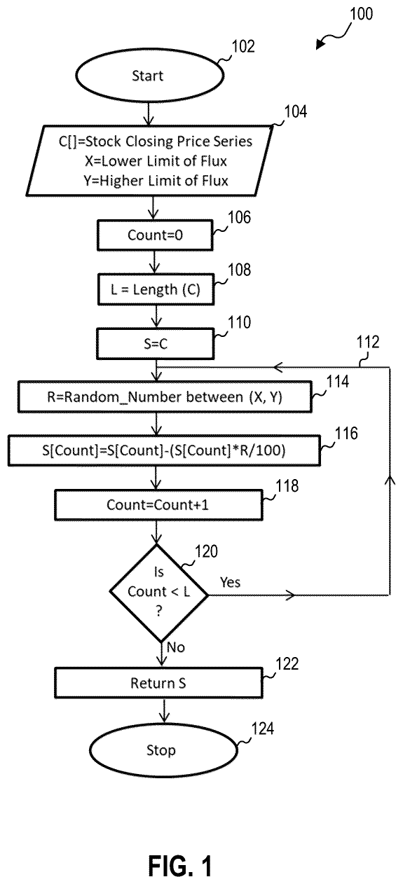

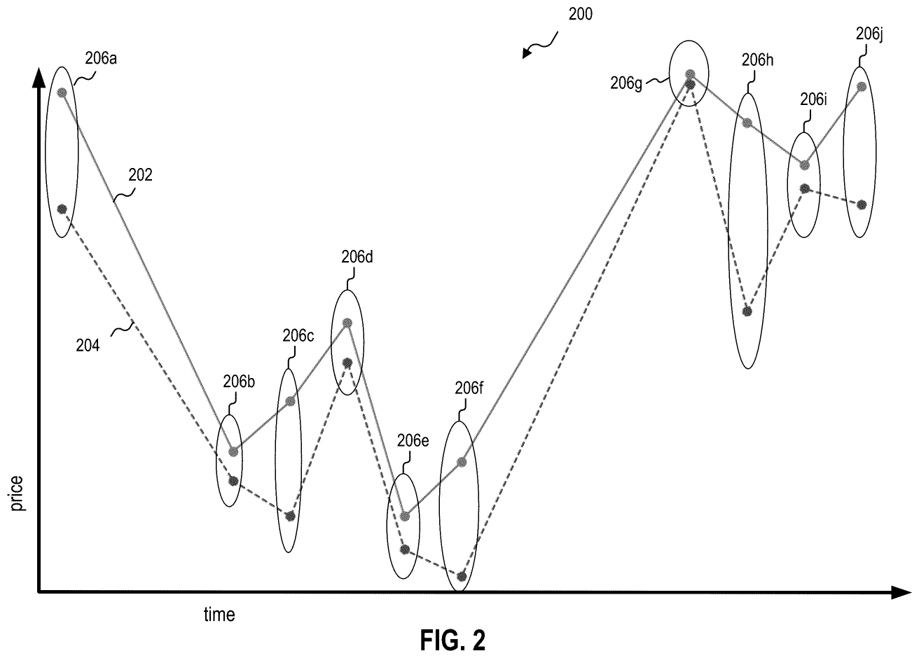

When generating peer stock data that is lower in value than the original (or reference) stock, the EchoFlux process includes (i) traversing through multiple price points (and in some instances, every price point) of series (C) of the original stock and (ii) duplicating those price points from series (C) as series(S), but with variations. To create the variations in series(S) from series (C), for each of the price points in series (C), a random number (R) within a range (X, Y) is generated. Thereafter, the considered point in series (C) is decreased by R % of its value. This procedure is described with reference to FIG. 1. An example of a synthetically generated series(S) along with its original series (C) is shown in FIG. 2, where the solid line represents the original series (C) and the dashed line represents the synthetically generated series(S). The X-axis represents time while Y-axis represents price.

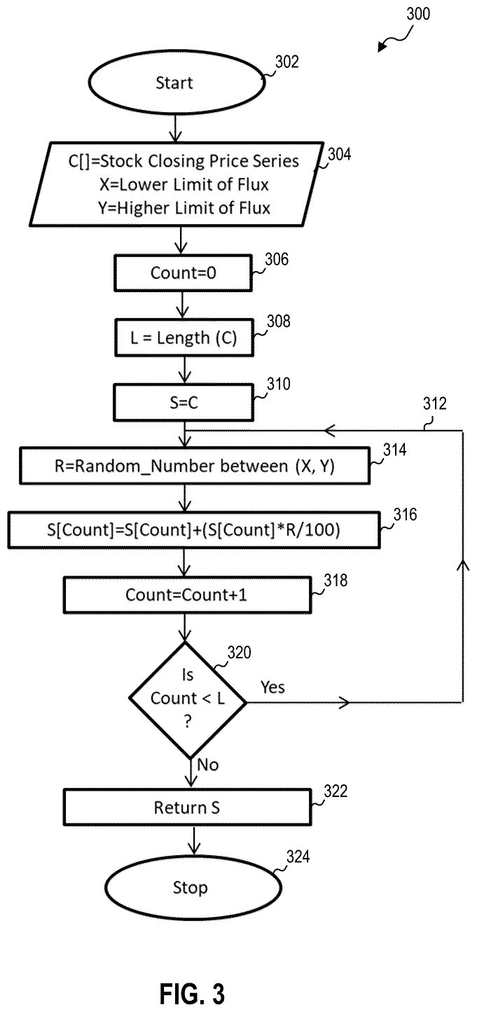

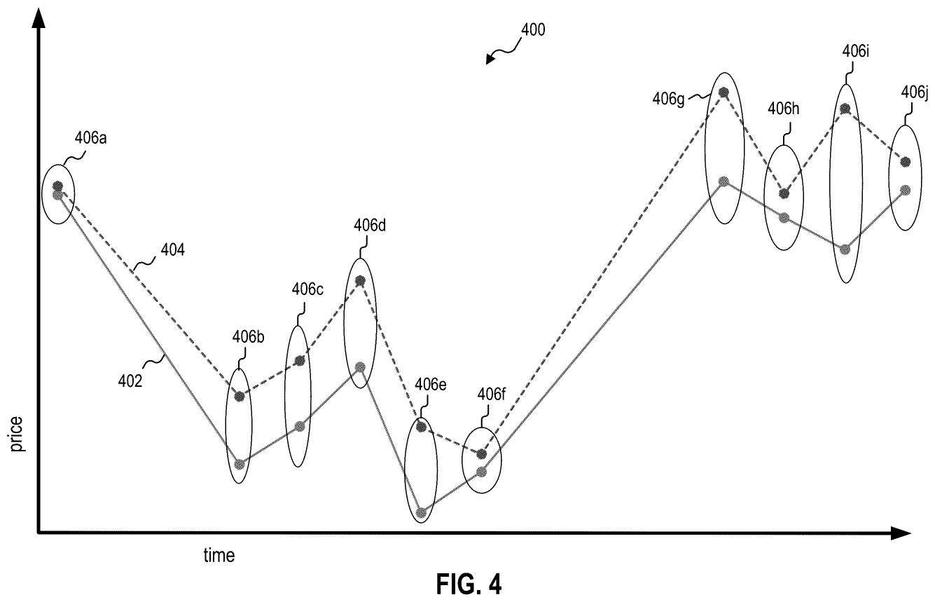

When generating peer stock data that is lower in value than the original (or reference) stock, the EchoFlux process includes (i) traversing through multiple price points (and in some instances, every price point) of series (C) of the original stock and (ii) duplicating those price points from series (C) as series(S), but with variations. To create the variations in series(S) from series (C) in this scenario, for each of the points in series (C), a random number (R) within a range (X, Y) is generated. Thereafter, the considered point in series (C) is increased by R % of its value. This procedure is described with reference to FIG. 3. An example of a synthetically generated series(S) along with its original series (C) is shown in FIG. 4. Here, the solid line represents the original series (C) while the dashed line represents the synthetically generated series(S). The X-axis represents time while Y-axis represents price.

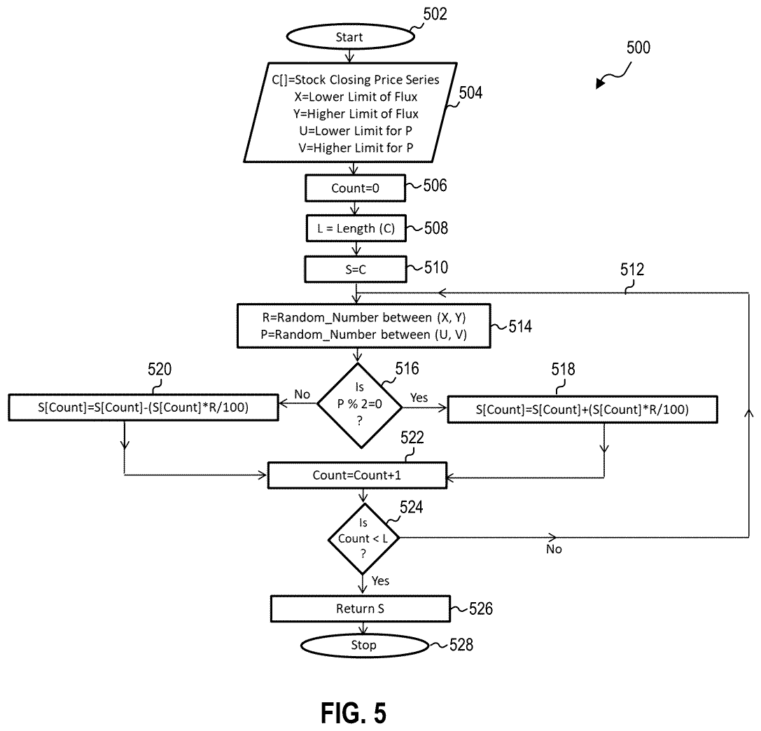

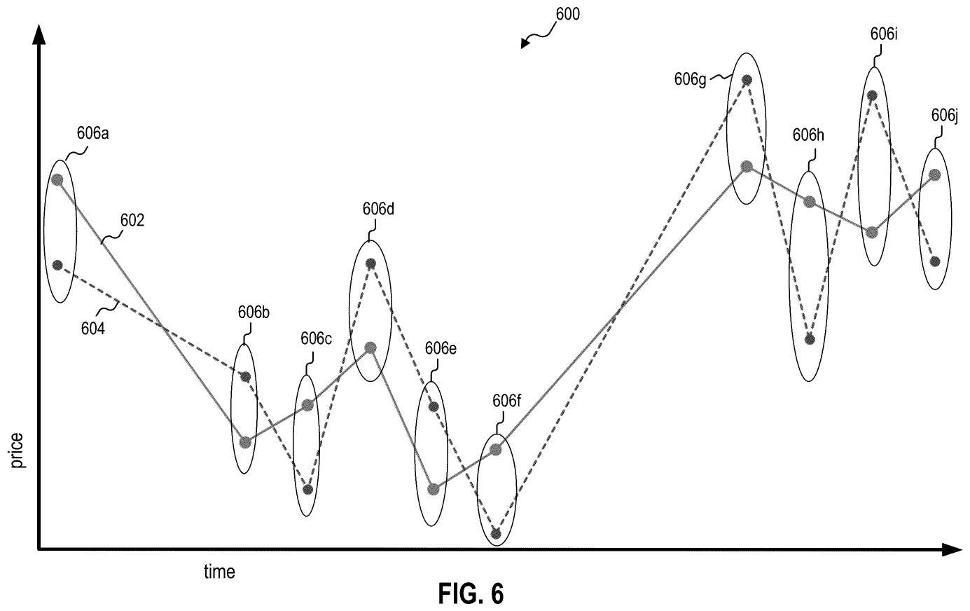

When generating peer stock data that intersects the value of the original (or reference) stock, the EchoFlux process includes (i) traversing through multiple price points (and in some instances, every price point) of series (C) of the original stock and (ii) duplicating those price points from series (C) as series(S), but with variations. To create the variations in series(S) from series (C), for each of the points in series (C), a random number (R) within range (X, Y) is generated. Additionally, another random number (P) is generated in the range (U,V). Thereafter, the considered point in series (C) is increased by R % of its value if P is even. Otherwise, the considered point in series (C) is decreased by R % of its value. This procedure is described with reference to FIG. 5. An example of a synthetically generated series(S) along with its original series (C) is shown in FIG. 6. Here, the solid line represents the original sequence while the dashed line represents the synthetically generated sequence. The X-axis represents time while Y-axis represents price.

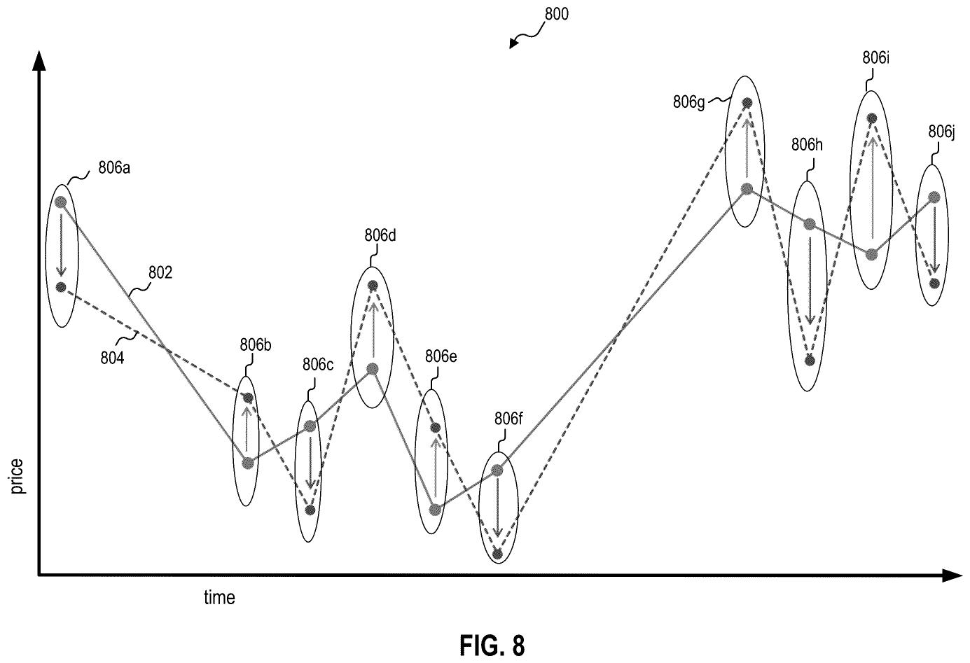

FIG. 8 shows synthetically generated stock prices indicated by a dashed line along with the original stock prices indicated by a solid line (as shown in FIG. 6). Here, the X-axis represents time while Y-axis represents price. In FIG. 8, the synthetically generated stock prices exceed the original stock prices at some points while the synthetically generated stock prices are lower than the original stock prices at other points. The points where the synthetic stock price is higher than the original stock price are represented using upward arrows while the contrary is represented using downward arrows. In operation, generating the synthetic stock data according to the disclosed processes ensures (or at least increases the likelihood) that the standard deviation of the synthetically generated stock is different from that of the original stock.

The disclosed processes can generate any number of synthetic stocks for an original stock by varying the range of deviation and the type of synthetic peer (e.g., generating synthetic peer data that is lower than the original data, generating synthetic peer that is greater than original data; and/or generating synthetic peer data that intersects the original data). Different types of synthetic peers with different ranges can also be combined with the original stock price data for training Machine Learning-based models. The synthetic peer stocks can also be generated based on opening price, closing price, midday price, hourly price, and/or any other price at any other time.

The example embodiments now will be described more fully hereinafter with reference to the accompanying figures, in which certain example embodiments are shown. The components shown and described with reference to the figures may, however, be embodied in many different forms and should not be construed as limited to the embodiments illustrated herein. Rather, the example embodiments disclosed herein are provided so that this disclosure will be thorough and complete, and will fully convey the scope of the inventions contained herein to those skilled in the art.

As used herein, the term “and/or” includes any and all combinations of one or more of the associated listed items.

Although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section.

As used herein, the singular forms “a,” “an,” and “the,” are intended to include the plural forms as well, unless the context clearly indicates otherwise. It will be further understood that the terms “comprises” and/or “comprising,” “includes” and/or “including,” and “have” and/or “having,” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

### I. Generating Synthetic Stock Price Data for a Synthetic Stock Based on Actual Stock Price Data for an Original Stock where the Synthetic Stock Prices in the Synthetic Stock Price Data are Always Less than the Original Stock Prices in the Original Stock Price Data

FIG. 1 shows an example method 100 for generating synthetic stock price data for a synthetic stock based on actual stock price data for an original stock where the synthetic stock prices in the synthetic stock price data is always less than the original stock prices in the original stock price data according to some embodiments.

Method 100 begins at block 102.

Next, at block 104, method 100 includes receiving a first series C of closing stock prices for an original (or reference) stock. Although the example in FIG. 1 is based on closing stock prices, method 100 is equally applicable to other price data, including but not limited to opening daily stock prices, hourly stock prices, weekly stock prices, monthly stock prices, quarterly stock prices, any combination of the foregoing, or any other pricing data suitable for use in training a machine learning system according the embodiments described herein.

In operation, the first series C for the original stock is a time-ordered sequence of actual historical price data of an actual security during a timeframe. The security can be any security listed on a financial exchange, including but not limited to a stock, a bond, a derivative, a market index, or any other type of security now known or later developed that has historical pricing data. The first series includes a market price of the actual security on the financial exchange at each time point of a plurality of time points during the timeframe.

In some embodiments, block 104 also includes setting a lower flux limit X and an upper flux limit Y. In other embodiments, the lower flux limit X and the upper flux limit Y are set before method 100 starts. These upper and lower limits are used in connection with creating synthetic pricing data during loop 112 of method 100 described further below.

In some embodiments, setting the lower flux limit X and the upper flux limit Y at block 104 includes setting the lower flux limit X and the upper flux limit Y based on one or more user inputs. In some embodiments, the lower flux limit X and the upper flux limit Y are based on one or more features of the first series C, e.g., an average inter-day or intra-day price fluctuation, a median inter-day or intra-day price fluctuation, or other feature suitable for setting the lower flux limit X and the upper flux limit Y.

Block 106 includes initializing a Count variable equal to zero. This Count variable corresponds to an individual data point (e.g., a price) in the first series C of closing stock prices.

Block 108 includes setting a series length L equal to the length of the first series C of closing stock prices for the original stock. In this context, the series length L corresponds to the number of data points in the first series C. For example, if the first series C of closing stock prices for the original stock received at block 104 includes 500 data points (i.e., 500 days of closing prices), then setting the series length L at block 108 entails setting series length L to 500.

Block 110 includes creating a second series S of closing stock prices for a synthetic stock. This second series S is initially equal to the first series C of closing stock prices for the original stock. However, the individual datapoints in the second series S will be modified in loop 112. This synthetic stock is a fictional security that is not listed on any financial exchange.

After setting the second series S equal to the first series C, method 100 begins loop 112 to update the individual closing stock prices in the second series S of closing stock prices for the synthetic stock with new values. The new values generated during the execution of loop 112 will be included in a dataset for training the machine learning model.

Loop 112 of method 100 begins at block 114, which includes setting variable R to a random number between the lower flux limit X and the upper flux limit Y from block 104.

Next, loop 112 advances to block 116, where an updated value of S[Count] is set to the original value of S[Count] (which is the same value as C [Count] for the original stock) multiplied by (R/100), which is then subtracted from the original value of S[Count].

For example, if the original value of S[0] is a value of 55, and the random number R is a value of 7, then block 116 includes updating the value of S[0] to a value of (55−55*( 7/100))=(55−3.85)=51.15. Similarly, if the original value of S[0] is 126, and the random number R is a value of 5, then block 116 includes updating the value of S[0] to a value of (126−126*( 5/100))=(126−6.3)=119.7. Because the original value of S[Count] is multiplied by (R/100) and then subtracted from the original value of S[Count], the updated value for S[Count] determined at block 116 will always be less than the original value for S[Count].

Next, loop 112 of method 100 advances to block 118, which includes updating the value for Count by one, i.e., setting Count=Count+1.

Next, loop 112 advances to block 120, which includes comparing the value for Count from block 118 to the series length L from block 108. If the value for Count is less than the series length L, then loop 112 returns to block 114 to generate the next value for the second series S. But if the value for Count is not less than the series length L, then loop 112 ends and method 100 advances to block 122.

At block 122, method 100 returns an updated series S for the synthetic stock. This series of stock price data is a synthetic time-ordered sequence of historical price data for the fictional security. This time-ordered sequence S of synthetic historical price data includes a synthetic price of the fictional security at each time point of the plurality of time points during the timeframe.

Next, method 100 ends at block 124.

FIG. 2 shows a chart 200 depicting prices of an original stock compared to synthetically generated prices of a synthetic peer created by the method 100 shown in FIG. 1 according to some embodiments.

Solid line 202 indicates the actual price history of the original stock as a function of time. Dotted line 204 indicates the synthetic price history of the synthetic stock as a function of time. At each of the datapoints 206a-j in the series, the synthetic price of the synthetic stock is lower than the actual price of the original stock.

### II. Generating Synthetic Stock Price Data for a Synthetic Stock Based on Actual Stock Price Data for an Original Stock where the Synthetic Stock Prices in the Synthetic Stock Price Data are Always Greater than the Original Stock Prices in the Original Stock Price Data

FIG. 3 shows an example method 300 for generating synthetic stock price data for a synthetic stock based on actual stock price data for an original stock where the synthetic stock prices in the synthetic stock price data is always greater than the original stock prices in the original stock price data according to some embodiments.

Method 300 begins at block 302.

Next, at block 304, method 300 includes receiving a first series C of closing stock prices for an original (or reference) stock. Although the example in FIG. 3 is based on closing stock prices, method 300 is equally applicable to other price data, including but not limited to opening daily stock prices, hourly stock prices, weekly stock prices, monthly stock prices, quarterly stock prices, any combination of the foregoing, or any other pricing data suitable for use in training a machine learning system according the embodiments described herein.

In operation, the first series C for the original stock is a time-ordered sequence of actual historical price data of an actual security during a timeframe. The security can be any security listed on a financial exchange, including but not limited to a stock, a bond, a derivative, a market index, or any other type of security now known or later developed that is has historical pricing data. The first series includes a market price of the actual security on the financial exchange at each time point of a plurality of time points during the timeframe.

In some embodiments, block 304 also includes setting a lower flux limit X and an upper flux limit Y. In other embodiments, the lower flux limit X and the upper limit Y are set before method 300 starts. These upper and lower limits are used in connection with creating synthetic pricing data during loop 312 described further below.

In some embodiments, setting the lower flux limit X and the upper flux limit Y at block 304 includes setting the lower flux limit X and the upper flux limit Y based on one or more user inputs. In some embodiments, the lower flux limit X and the upper flux limit Y are based on one or more features of the first series C, e.g., an average inter-day or intra-day price fluctuation, a median inter-day or intra-day price fluctuation, or other feature suitable for setting the lower flux limit X and the upper flux limit Y.

Block 306 includes initializing a Count variable equal to zero. This Count variable corresponds to an individual data point (e.g., a price) in the series of closing stock prices.

Block 308 includes setting a series length L equal to the length of the first series C of closing stock prices for the original stock. In this context, the series length L corresponds to the number of data points in the first series C. For example, if the first series C of closing stock prices for the original stock received at block 304 includes 500 data points (i.e., 500 days of closing prices), then setting the series length L at block 308 entails setting series length L to 500.

Block 310 includes creating a second series S of closing stock prices for a synthetic stock. This second series S is initially equal to the first series C of closing stock prices for the original stock. However, the individual datapoints in the second series S will be modified in loop 312. This synthetic stock is a fictional security that is not listed on any financial exchange.

After setting the second series S equal to the first series C, method 300 begins loop 312 to update the individual closing stock prices in the second series S of closing stock prices for the synthetic stock with new values. The new values generated during the execution of loop 112 will be included in the dataset for training the machine learning model.

Loop 312 of method 300 begins at block 314, which includes setting variable R to a random number between the lower flux limit X and the upper flux limit Y from block 304.

Next, loop 312 advances to block 316, where an updated value of S[Count] is set to the original value of S[Count] (which is the same value as C [Count] for the original stock) multiplied by (R/100), which is then added to the original value of S[Count].

For example, if the original value of S[0] is a value of 55, and the random number R is a value of 7, then block 316 would update the value of S[0] to a value of (55+55*( 7/100))=(55+3.85)=58.85. Similarly, if the original value of S[0] is 126, and the random number R is a value of 5, then block 316 would update the value of S[0] to a value of (126+126*( 5/100))=(126+6.3)=132.3. Because the original value of S[Count] is multiplied by (R/100) and then added to the original value of S[Count], the updated value for S[Count] determined at block 316 will always be greater than the original value for S[Count].

Next, loop 312 of method 300 advances to block 318, which includes updating the value for Count by one, i.e., setting Count=Count+1.

Next, loop 312 advances to block 320, which includes comparing the value for Count from block 318 to the series length L from block 308. If the value for Count is less than the series length L, then loop 312 returns to block 314 to generate the next value for the second series S. But if the value for Count is not less than the series length L, then loop 312 ends and method 100 advances to block 322.

At block 322, method 300 returns an updated series S for the synthetic stock. This series of stock price data is a synthetic time-ordered sequence of historical price data for the fictional security. This time-ordered sequence S of synthetic historical price data includes a synthetic price of the fictional security at each time point of the plurality of time points during the timeframe.

Next, method 300 ends at block 324.

FIG. 4 shows a chart 400 depicting prices of an original stock compared to synthetically generated prices of a synthetic peer stock created by the method 300 shown in FIG. 1 according to some embodiments.

Solid line 402 indicates the actual price history of the original stock as a function of time. Dotted line 404 indicates the synthetic price history of the synthetic stock as a function of time. At each of the datapoints 406a-j in the series, the synthetic price of the synthetic stock is greater than the actual price of the original stock.

### III. Generating Synthetic Stock Price Data for a Synthetic Stock Based on Actual Stock Price Data for an Original Stock where the Synthetic Stock Prices in the Synthetic Stock Price Data are Both (i) Less than the Original Stock Prices in the Original Stock Price Data and (ii) Greater than the Original Stock Prices in the Original Stock Price Data

FIG. 5 shows an example method 500 for generating synthetic stock price data for a synthetic stock based on actual stock price data for an original stock where the synthetic stock prices in the synthetic stock price data are both (i) less than the original stock prices in the original stock price data and (ii) greater than the original stock prices in the original stock price data, according to some embodiments.

Method 500 begins at block 502.

Next, at block 504, method 500 includes receiving a first series C of closing stock prices for an original (or reference) stock. Although the example in FIG. 5 is based on closing stock prices, method 500 is equally applicable to other price data, including but not limited to opening daily stock prices, hourly stock prices, weekly stock prices, monthly stock prices, quarterly stock prices, any combination of the foregoing, or any other pricing data suitable for use in training a machine learning system according the embodiments described herein.

In operation, the first series C for the original stock is a time-ordered sequence of actual historical price data of an actual security during a timeframe. The security can be any security listed on a financial exchange, including but not limited to a stock, a bond, a derivative, a market index, or any other type of security now known or later developed that is has historical pricing data. The first series includes a market price of the actual security on the financial exchange at each time point of a plurality of time points during the timeframe.

In some embodiments, block 504 also includes (i) setting a lower flux limit X and an upper flux limit Y, and (ii) setting a lower P limit U and an upper P limit V. In other embodiments, one or more (or all) of the lower flux limit X, the upper limit Y, the lower P limit U, and the upper P limit V are set before method 500 starts. These the values for X, Y, U, and V are used in connection with creating synthetic pricing data during the execution of loop 512 described further below.

In some embodiments, setting the lower flux limit X and the upper flux limit Y at block 504 includes setting the lower flux limit X and the upper flux limit Y based on one or more user inputs. In some embodiments, the lower flux limit X and the upper flux limit Y are based on one or more features of the first series C, e.g., an average inter-day or intra-day price fluctuation, a median inter-day or intra-day price fluctuation, or other feature suitable for setting the lower flux limit X and the upper flux limit Y.

Block 506 includes initializing a Count variable equal to zero. This Count variable corresponds to an individual data point (e.g., a price) in the series C of closing stock prices.

Block 508 includes setting a series length L equal to the length of the first series C of closing stock prices for the original stock. In this context, the series length L corresponds to the number of data points in the first series C. For example, if the first series C of closing stock prices for the original stock received at block 504 includes 1000 data points (i.e., 1000 days of closing prices), then setting the series length L at block 508 entails setting series length L to 1000.

Block 510 includes creating a second series S of closing stock prices for a synthetic stock. This second series S is initially equal to the first series C of closing stock prices for the original stock. However, the individual datapoints in the second series S will be modified in loop 512. This synthetic stock is a fictional security that is not listed on any financial exchange.

After setting the second series S equal to the first series C, method 500 begins loop 512 to update the individual closing stock prices in the second series S of closing stock prices for the synthetic stock with new values. The new values generated during the execution of loop 512 will be used for training the machine learning model.

Loop 512 of method 500 begins at block 514, which includes (i) setting variable R to a random number between the lower flux limit X and the upper flux limit Y from block 504, and (ii) setting variable P to a random number between the lower P limit U and the upper P limit V from block 504.

Next, loop 512 advances to block 516 which includes determining whether the value of P set at block 514 is an even number or an odd number. When P is an even number, then loop 512 advances to block 518. When P is an odd number, then loop 512 advances to block 520.

At block 518 (when P is even), an updated value of S[Count] is set to the original value of S[Count] (which is the same value as C [Count] for the original stock) multiplied by (R/100), which is then added to the original value of S[Count].

For example, if the original value of S[0] is a value of 55, and the random number R (set at block 514) is a value of 7, then block 518 includes updating the value of S[0] to a value of (55+55*( 7/100))=(55+3.85)=58.85. Similarly, if the original value of S[0] is 126, and the random number R is a value of 5, then block 518 includes updating the value of S[0] to a value of (126+126*( 5/100))=(126+6.3)=132.3. Because the original value of S[Count] is multiplied by (R/100) and then added to the original value of S[Count], the updated value for S[Count] determined at block 518 will always be greater than the original value for S[Count].

At block 520 (when P is odd), an updated value of S[Count] is set to the original value of S[Count] (which is the same value as C [Count] for the original stock) multiplied by (R/100), which is then subtracted from the original value of S[Count].

For example, if the original value of S[0] is a value of 55, and the random number R (set at block 514) is a value of 7, then block 520 would update the value of S[0] to a value of (55−55*( 7/100))=(55−3.85)=51.15. Similarly, if the original value of S[0] is 126, and the random number R is a value of 5, then block 520 would update the value of S[0] to a value of (126−126*( 5/100))=(126−6.3)=119.7. Because the original value of S[Count] is multiplied by (R/100) and then subtracted from the original value of S[Count], the updated value for S[Count] determined at block 520 will always be less than the original value for S[Count].

After executing one of block 518 or block 520, loop 512 advances to block 522, which includes updating the value for Count by one, i.e., setting Count=Count+1.

Next, loop 512 advances to block 524, which includes comparing the value for Count from block 522 to the series length L from block 508. If the value for Count is less than the series length L, then loop 512 returns to block 514 to generate the next value for the second series S. But if the value for Count is not less than the series length L, then loop 512 ends and method 500 advances to block 526.

At block 526, method 500 returns an updated series S for the synthetic stock. This series of stock price data is a synthetic time-ordered sequence of historical price data for the fictional security. This time-ordered sequence S of synthetic historical price data includes a synthetic price of the fictional security at each time point of the plurality of time points during the timeframe.

Next, method 500 ends at block 528.

FIG. 6 shows a chart 600 depicting prices of an original stock compared to synthetically generated prices of a synthetic peer stock created by the method 500 shown in FIG. 5 according to some embodiments.

Solid line 602 indicates the actual price history of the original stock as a function of time. Dotted line 604 indicates the synthetic price history of the synthetic stock as a function of time. Because method 500 generates synthetic stock prices that are both higher and lower than the original stock prices, the synthetic stock prices at different datapoints within the series may be higher or lower than the original stock prices. For example, the synthetic price of the synthetic stock is greater than the actual price of the original stock at datapoints 606b, 606d, 606e, 606g, and 606i. And the synthetic price of the synthetic stock is lower than the actual price of the original stock at datapoints 606a, 606c, 606f, 606h, and 606j.

### IV. Merging Synthetic Stock Price Data with Original Stock Price Data in a Matrix Suitable for Use with Training a Machine Learning Model

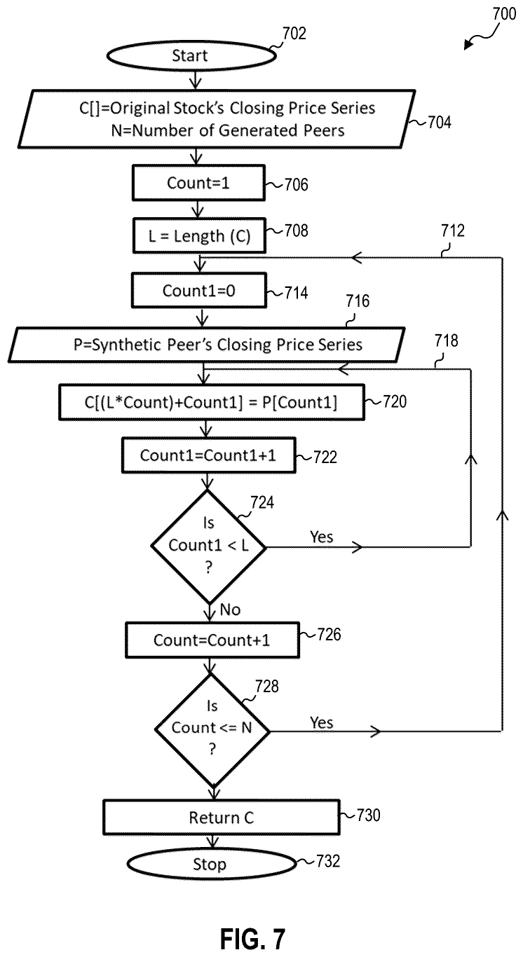

FIG. 7 shows an example method 700 for merging original stock data with synthetically generated stock data according to some embodiments.

Method 700 begins at block 702.

Next, at block 704, method 700 includes receiving a first series C of closing stock prices for an original stock. Although the example in FIG. 7 is based on closing stock prices, method 700 is equally applicable to other price data, including but not limited to opening daily stock prices, hourly stock prices, weekly stock prices, monthly stock prices, quarterly stock prices, any combination of the foregoing, or any other pricing data suitable for use in training a machine learning system according the embodiments described herein.

In operation, the first series C for the original stock is a time-ordered sequence of actual historical price data of an actual security during a timeframe. The security can be any security listed on a financial exchange, including but not limited to a stock, a bond, a derivative, a market index, or any other type of security now known or later developed that is has historical pricing data. The series of closing stock prices includes a market price of the actual security on the financial exchange at each time point of a plurality of time points during the timeframe.

In some embodiments, block 704 also includes setting a value N corresponding to a number of generated peers. This number N corresponds to the number (i.e., quantity) of synthetic stocks (and their corresponding series of synthetic stock data generated by any of methods 100, 300, and/or 500) to be combined into a training dataset with the first series C of closing stock prices for the original stock. For example, if 10 synthetic peer stocks (having 10 corresponding sets of synthetic stock data) have been generated and are to be merged into a dataset with the first series C of data, then N is set to 10. Similarly, if 50 synthetic peer stocks (having 50 corresponding sets of synthetic stock data) have been generated and are to be merged into a dataset with the first series C of data, then N is set to 50.

Block 706 includes initializing a Count value equal to one, which corresponds to the first synthetic stock (i.e., synthetic peer) and its series of synthetic stock data to be merged (or combined) into the training dataset with the first series C of actual stock data for the original stock. After executing method 700, the training dataset will include (i) the first time-ordered sequence of stock price data for the original stock (i.e., the first series C) and (ii) N additional sets of time-ordered sequences of stock price data, i.e. one set of synthetic data for each of the N synthetic peer stocks having synthetic pricing data generated by any one or more of methods 100, 300, and/or 500.

Block 708 includes setting a series length L equal to the length of the first series C of closing stock prices for the original stock. In this context, the series length L corresponds to the number of data points in first series C of stock price data for the original stock, i.e., the number of data points in the first time-ordered sequence C of stock price data for the original stock. For example, if the first series C of closing stock prices for the original stock received at block 704 includes 500 data points (i.e., 500 days of closing prices), then setting the series length L at block 708 entails setting series length L to 500.

Next, method 700 advances to loop 712.

Loop 712 of method 700 begins at block 714, which includes setting a Count1 variable to zero. The Count1 variable in block 714 corresponds to an individual data point (e.g., a synthetic closing price) in an individual series of time-ordered price data for an individual synthetic peer. These individual synthetic data points (e.g., the generated/synthetic time-ordered closing prices) for the synthetic peer will be combined into a training dataset with the first series C of actual data points (e.g., the actual time-ordered closing prices) for the original/actual stock. This training dataset will be used to train a machine learning model (e.g., a regression model) configured to predict future prices for the actual stock.

Next, loop 712 advances to block 716, which includes receiving a series P of closing stock prices for a particular synthetic peer. In operation, the series P is a series of stock price data for an individual synthetic peer that has been generated by any of methods 100, 300, and/or 500. The individual datapoints in this series P will be added to a matrix that contains the individual datapoints in the first series C of the original stock on which the data in the series P is based.

Next loop 712 advances to subloop 718. Subloop 718 is a nested loop within loop 712 of method 700. In operation, subloop 718 adds each individual synthetic peer datapoint (i.e., each closing price) for the series P of synthetic data points to the matrix that includes the first series C of data points for the original stock.

At block 720, subloop 718 includes, adding a datapoint P [Count1] from peer data set P to the matrix that includes the first set C of data for the original stock.

After adding the datapoint P [Count1] from the peer dataset P to the matrix, subloop 718 advances to block 722, which includes incrementing the Count1 value by one, i.e., setting Count1=Count1+1.

Next, subloop 718 advances to block 724, which includes comparing the value for Count1 from block 722 to the series length L from block 708. If the value for Count1 is less than the series length L, then subloop 718 returns to block 720 to add the next datapoint P [Count1] from the peer dataset P to the matrix.

But if the value for Count1 is not less than the series length L, there are no more datapoints in P to add to the matrix. So, subloop 718 ends at block 724 and loop 712 advances to block 726, which includes incrementing the Count value by one, i.e., setting Count=Count+1. In operation, updating Count by one amounts to moving on to the next peer data set of the N total peer datasets.

Next, loop 712 advances to block 728, which includes comparing the value for Count from block 706 to N (i.e., the total number (quantity) of sets of peer data) from block 704. If the current value for Count (set at block 726) is less than the value of N (set at block 704), then loop 712 returns to block 714 to add the next series P of data points to the matrix. But if the current value for Count (set at block 726) is not less than the value of N (set at block 704), then loop 712 ends and method 700 advances to block 730, which includes returning the matrix of pricing data. The matrix returned at block 732 includes (i) the first time-ordered sequence of stock price data for the original stock (i.e., the first series C) and (ii) N additional sets of time-ordered sequences of stock price data, i.e., one set of synthetic data for each of the synthetic peer stocks generated by any one or more of methods 100, 300, and/or 500.

Next, method 700 ends at block 732.

FIG. 8 shows a chart depicting prices of an original stock compared to synthetically generated prices of a synthetic peer stock created by the methods 100, 300, and/or 500 showing positive and negative deviations in the synthetic peer stock relative to the original stock according to some embodiments.

Solid line 802 indicates the actual price history of the original stock as a function of time. Dotted line 804 indicates the synthetic price history of the synthetic stock as a function of time. Because methods 100, 300, and 500 generate synthetic stock prices that are both higher and lower than the original stock prices, the synthetic stock prices at different datapoints within the series may be higher or lower than the original stock prices.

For example, the synthetic price of the synthetic stock (dotted line 804) is greater than the actual price of the original stock (solid line 802) at datapoints 806b, 806d, 806e, 806g, and 806i. And the synthetic price of the synthetic stock (dotted line 804) is lower than the actual price of the original stock (solid line 802) at datapoints 806a, 806c, 806f, 806h, and 806j. Arrows pointing up at a datapoint indicate where the deviation between the synthetic price relative to the original price is positive, and arrows pointing down at a datapoint indicate where the deviation between the synthetic price relative to the original price is negative.

### V. Example Methods

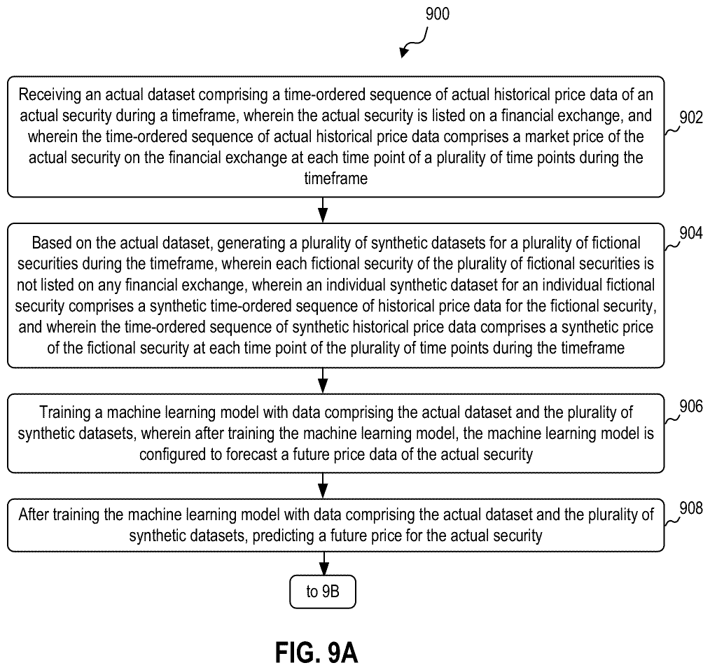

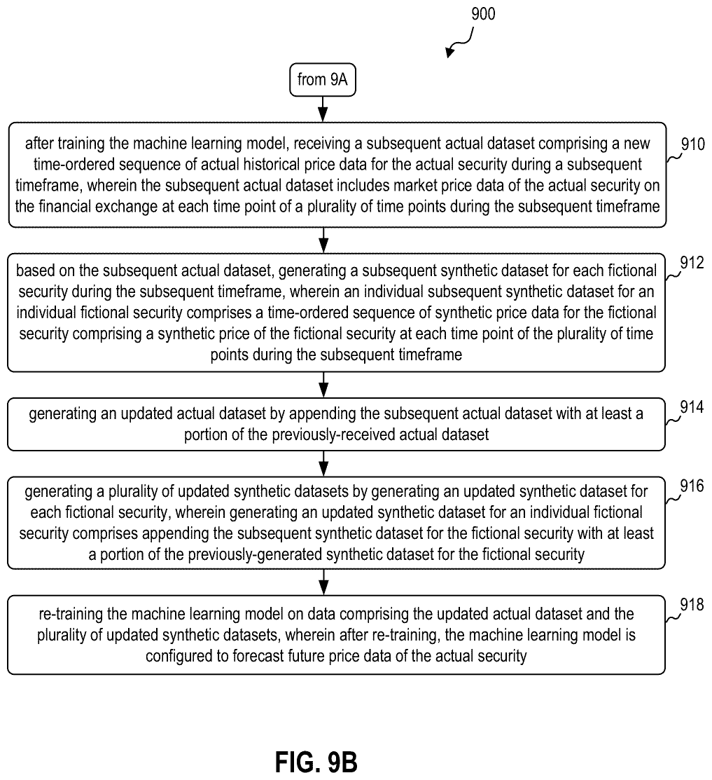

FIG. 9A shows aspects of an example method 900 for generating synthetic data for machine learning according to some embodiments. FIG. 9B shows additional aspects of the method 900 for generating synthetic data for machine learning according to some embodiments.

Method 900 begins at step 902, which includes receiving an actual dataset comprising a time-ordered sequence of actual historical price data of an actual security during a timeframe, where the actual security is listed on a financial exchange, and where the time-ordered sequence of actual historical price data comprises a market price of the actual security on the financial exchange at each time point of a plurality of time points during the timeframe. The actual security may be any one of (i) a stock, (ii) a bond, (iii) a derivative, (iv) a market index, or (v) any other security now known or later developed that is traded on a financial exchange and has pricing history.

Next, method 900 advances to step 904, which includes, based on the actual dataset, generating a plurality of synthetic datasets for a plurality of fictional securities during the timeframe, wherein each fictional security of the plurality of fictional securities is not listed on any financial exchange, wherein an individual synthetic dataset for an individual fictional security comprises a synthetic time-ordered sequence of historical price data for the fictional security, and wherein the time-ordered sequence of synthetic historical price data comprises a synthetic price of the fictional security at each time point of the plurality of time points during the timeframe.

In some embodiments, generating a plurality of synthetic datasets for a plurality of fictional securities during the timeframe at step 904 includes, for an individual fictional security: (i) for each market price of the actual security at each time point of the plurality of time points during the timeframe, generating a synthetic price at the time point by multiplying the market price by a random number, wherein market prices at different time points are multiplied by different random numbers to generate the synthetic prices at the different time points; and (ii) ordering the generated synthetic prices based on their corresponding time points into a synthetic dataset for the individual fictional security. In some embodiments, the random number is within a range defined by a lower bound and an upper bound.

In some embodiments, generating a synthetic price at the time point by multiplying the market price by a random number comprises any one or more of: (i) multiplying the market price by a random number that is less than 1, thereby resulting in a corresponding synthetic price that is lower than the market price at the time point; (ii) multiplying the market price by a random number that is greater than 1, thereby resulting in a corresponding synthetic price that is higher than the market price at the time point; and/or (iii) generating a synthetic price at the time point by multiplying the market price by a first random number based on a second random number that is different than the first random number, where (a) when the second random number has a first attribute, the first random number is less than one, thereby resulting in a corresponding synthetic price that is lower than the market price at the time point, and (b) when the second random number has a second attribute, the first random number is greater than one, thereby resulting in a corresponding synthetic price that is higher than the market price at the time point. In some embodiments, the first attribute includes having an even value and the second attribute includes having an odd value. In some embodiments, the first attribute includes having a positive value and the second attribute includes having a negative value.

In some embodiments, generating the plurality of synthetic datasets for the plurality of fictional securities during the timeframe at step 904 includes, for an individual synthetic dataset for an individual fictional security: (i) applying a bi-stage transformation to each data point sᵢ of the actual dataset to produce a corresponding synthetic data point pᵢ for the synthetic dataset, wherein the bi-stage transformation is defined by an equation pᵢ=(sᵢθᵢ) ψᵢsᵢ, where θᵢ represents a maximum deviation percentage of pᵢ from sᵢ, and ψᵢ represents an associativity factor that determines a direction of deviation that is positive or negative. In some such embodiments, generating the plurality of synthetic datasets for the plurality of fictional securities during the timeframe at step 904 additionally includes: (i) selecting a value for θᵢ within a predetermined range of 0 to L, where L is a predefined maximum deviation limit, and θᵢ is a real number between 0 and L; and (ii) setting ψᵢ to a positive or negative value, wherein (i) when ψᵢ is positive, synthetic price pᵢ is greater than or equal to actual price sᵢ, and (ii) when ψᵢ is negative, synthetic price pᵢ is less than or equal to actual price sᵢ.

Next, method 900 advances to step 906, which includes training a machine learning model with data comprising the actual dataset and the plurality of synthetic datasets, wherein after training the machine learning model, the machine learning model is configured to forecast a future price data of the actual security. In some embodiments, the machine learning model comprises a regression model.

In some embodiments, training the machine learning model with data comprising the actual dataset and the plurality of synthetic datasets at step 906 includes: (i) for the actual security, extracting one or more features from price data in the actual dataset; (ii) for the plurality of fictional securities, for each fictional security, extracting the one or more features from price data in the synthetic dataset for the fictional security; and (iii) training the model to predict the future price of the actual security based at least in part on the one or more extracted features from the price data in the actual dataset and the one or more extracted features from the price data in each synthetic dataset. In some embodiments, the one or more extracted features include technical indicators associated with the actual security and the fictional securities.

In some embodiments, the one or more extracted features include one or more of: (i) a Relative Strength Index (RSI) that quantifies a speed and change of price movement of the price data, (ii) a Moving Average Convergence/Divergence (MACD) using two exponential moving averages of different timeframes to identify a strength of a directional move in the price data, (iii) an Average Direction Index (ADX) that measures a strength and momentum of change in the price data, (iv) a Stochastic Oscillator that measures a current price relative to a price range over a number of periods, which is useful as a momentum indicator to show how a security's price has changed over a given period of time, (v) a Simple Moving Average (SMA) that measures an average price over a specific time period, or (vi) a Standard Deviation that measures volatility in the price data.

Some embodiments of method 900 additionally include step 908, which includes after training the machine learning model with data comprising the actual dataset and the plurality of synthetic datasets at step 906, predicting a future price for the actual security.

Some embodiments additionally include steps 910 through 918. Steps 910 through 918 relate to updating the training data based on new historical data associated with the actual security. In operation, steps 910 through 918 may be performed after collecting some threshold number of new datapoints for the actual security. For example, steps 910 through 918 may be performed after collecting any of (i) one or more days of new datapoints, (ii) one or more weeks of new datapoints, (iii) one or more months of new datapoints, and/or (iv) one or more quarters of new datapoints.

Step 910 includes, after training the machine learning model, receiving a subsequent actual dataset comprising a new time-ordered sequence of actual historical price data for the actual security during a subsequent timeframe, wherein the subsequent actual dataset includes market price data of the actual security on the financial exchange at each time point of a plurality of time points during the subsequent timeframe.

After step 910, method 900 advances to step 912, which includes based on the subsequent actual dataset, generating a subsequent synthetic dataset for each fictional security during the subsequent timeframe, wherein an individual subsequent synthetic dataset for an individual fictional security comprises a time-ordered sequence of synthetic price data for the fictional security comprising a synthetic price of the fictional security at each time point of the plurality of time points during the subsequent timeframe.

Next, method 900 advances to step 914, which includes generating an updated actual dataset by appending the subsequent actual dataset with at least a portion of the previously-received actual dataset. In some embodiments, generating the updated actual dataset additionally includes removing a quantity of old datapoints equal to the quantity of new datapoints. For example, if the subsequent timeframe is one month, updating the actual dataset may include (i) adding the new month of datapoints to the actual dataset and (ii) removing the oldest month of datapoints from the actual dataset.

Next, method 900 advances to step 916, which includes generating a plurality of updated synthetic datasets by generating an updated synthetic dataset for each fictional security, wherein generating an updated synthetic dataset for an individual fictional security comprises appending the subsequent synthetic dataset for the fictional security with at least a portion of the previously-generated synthetic dataset for the fictional security.

At step 918, method 900 includes re-training the machine learning model on data comprising the updated actual dataset and the plurality of updated synthetic datasets, wherein after re-training, the machine learning model is configured to forecast future price data of the actual security.

### VII. Example Computing System

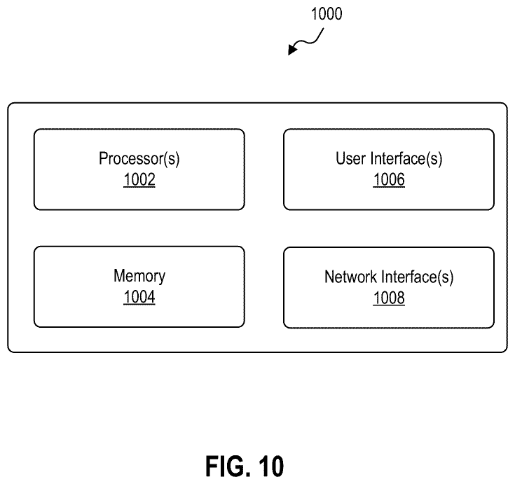

FIG. 10 shows an example computing system 1000 configured for implementing one or more (or all) aspects of the methods and processes disclosed herein.

Computing system 1000 includes one or more processors 1002, one or more tangible, non-transitory computer-readable memory 1004, one or more user interfaces 1006, and one or more network interfaces 1008.

The one or more processors 1002 may include any type of computer processor now known or later developed that is suitable for performing one or more (or all) of the disclosed features and functions, individually or in combination with one or more additional processors

The one or more tangible, non-transitory computer-readable memory 1004 is configured to store program instructions that are executable by the one or more processors 1002.

The program instructions, when executed by the one or more processors 1002 cause the computing system to perform any one or more (or all) of the functions disclosed and described herein. In operation, the one or more tangible, non-transitory computer-readable memory 1004 is also configured to store data (e.g., pricing data, training data, forecasted pricing) that is both used in connection with performing the disclosed functions and generated via performing the disclosed functions.

The one or more user interfaces 1006 may include any one or more of a keyboard, monitor, touchscreen, mouse, trackpad, voice interface, or any other type of user interface now known or later developed that is suitable for receiving inputs from a computer user or another computer and/or providing outputs to a computer user or another computer.

The one or more network interfaces 1008 may include any one or more wired and/or wireless network interfaces, including but not limited to Ethernet, optical, WiFi, Bluetooth, or any other network interface now known or later developed that is suitable for enabling the computing system 1000 to receive data from other computing devices and systems and/or transmit data to other computing devices and systems.

The computing system 1000 corresponds to any one or more of a desktop computer, laptop computer, tablet computer, smartphone, and/or computer server acting individually or in combination with each other to perform the disclosed features.

### VIII. Validation and Experimental Results

A stock price forecasting experiment was conducted in three phases to assess the efficacy of the stock prices predicted by a machine learning model trained with the synthetic price data generated by the methods shown and described with reference to FIGS. 1-9. The dataset included the 500 stocks in the S&P 500 and 252 days of price data, which is the average number of working days in a year. A prediction was made for each of the actual stocks in the dataset. The predictions were made using regression models implemented with XGBoost (Extreme Gradient Boosting). XGBoost is an open-source software library that provides a regularizing gradient boosting framework for use with implementing machine learning regression models that can be trained to make future predictions based in part on historical data. For the testing, regression models implemented with XGBoost were trained with three different training datasets referred to as Phase One, Phase Two and Phase Three (described below) and the accuracy of the predictions that were generated with each training dataset were compared.

### A. Phase One

In Phase One, a stock price forecasting model was trained separately for each of the 500 stocks in the dataset. For each stock in the dataset, the entire available history of price data for the stock for was used to train the model for that stock. Standard technical features were computed on this historical price data, and the target was set as the closing price for the stock (i.e., the closing price of the i^{th} day of the stock was set as the target for the features of the i^{th} day for the stock). The daily features for each date and the corresponding target for each date are illustrated in the following table.

| Date | Feature 1 | Feature 2 | Feature 3 | Feature 4 | Target |
|---|---|---|---|---|---|
| D₁ | F₁D₁ | F₂D₁ | F₃D₁ | F₄D₁ | T₁ |
| D₂ | F₁D₂ | F₂D₂ | F₃D₂ | F₄D₂ | T₂ |
| D₃ | F₁D₃ | F₂D₃ | F₃D₃ | F₄D₃ | T₃ |
| D₄ | F₁D₄ | F₂D₄ | F₃D₄ | F₄D₄ | T₄ |

The forecasting performance for a single stock for a single day was evaluated as the unsigned percentage deviation of the forecasted price with respect to the actual price (error). The average error for 252 days (i.e., the testing period) was computed for each of the stocks. The average of this error across the 500 stocks was computed to assess the performance for Phase One where the entire available history of price data for each stock was used for training the model for each stock.

### B. Phase Two

In Phase Two, only the most recent 600 days of history was used in the dataset used to train the model for each stock. The test period for Phase Two was the same 252 day period that was used in Phase One. The training scheme and the evaluation was exactly same as that of Phase One. Phase Two was implemented to assess how well the models for each stock would perform when each model was trained with a smaller amount of data (e.g., only the most recent 600 days of data for the stock) compared to the performance of the models when each model was trained with entire available history of price data for the stock.

### C. Phase Three

The Phase Three used (i) the same data that was used in Phase Two and (ii) synthetic data that was generated based on the 600 data points for each of the stocks. In operation, the synthetic data was generated according to the methods disclosed and described with reference to FIGS. 1-9. The length (i.e., number of datapoints) of this synthetic data was identical to the length (i.e., number of datapoints) of the actual data. The table below illustrates the relationships between the original data and the synthetic data, where OᵢSⱼ refers to the i^{th} data point for the j^{th} synthetic data sequence.

| Original Data | Synthetic Data 1 | Synthetic Data 2 | Synthetic Data 3 |
|---|---|---|---|
| O₁ | O₁S₁ | O₁S₂ | O₁S₃ |
| O₂ | O₂S₁ | O₂S₂ | O₂S₃ |
| O₃ | O₃S₁ | O₃S₂ | O₃S₃ |
| O₄ | O₄S₁ | O₄S₂ | O₄S₃ |

In Phase Three, features were computed for each data sequence, and all the feature-target pairs were joined to form the training set used for model training. The temporal resolution of the data from which the features were extracted did not affect the targets obtained from the data because the correlation between the extracted features and the corresponding targets took the form of (Featuresᵢ, Targetᵢ).

The table below illustrates a representation of the final training set, where SᵢFⱼDₖ refers to the j^{th} feature of the k^{th} instance for the i^{th} synthetic sequence.

| Data | Feature 1 | Feature 2 | Feature 3 | Feature 4 | Target |
|---|---|---|---|---|---|
| Original | OF₁D₁ | OF₂D₁ | OF₃D₁ | OF₄D₁ | OT₁ |
| Data | OF₁D₂ | OF₂D₂ | OF₃D₂ | OF₄D₂ | OT₂ |
| | OF₁D₃ | OF₂D₃ | OF₃D₃ | OF₄D₃ | OT₃ |
| | OF₁D₄ | OF₂D₄ | OF₃D₄ | OF₄D₄ | OT₄ |
| Synthetic | S₁F₁D₁ | S₁F₂D₁ | S₁F₃D₁ | S₁F₄D₁ | S₁T₁ |
| Data 1 | S₁F₁D₂ | S₁F₂D₂ | S₁F₃D₂ | S₁F₄D₂ | S₁T₂ |
| | S₁F₁D₃ | S₁F₂D₃ | S₁F₃D₃ | S₁F₄D₃ | S₁T₃ |
| | S₁F₁D₄ | S₁F₂D₄ | S₁F₃D₄ | S₁F₄D₄ | S₁T₄ |
| Synthetic | S₂F₁D₁ | S₂F₂D₁ | S₂F₃D₁ | S₂F₄D₁ | S₂T₁ |
| Data 2 | S₂F₁D₂ | S₂F₂D₂ | S₂F₃D₂ | S₂F₄D₂ | S₂T₂ |
| | S₂F₁D₃ | S₂F₂D₃ | S₂F₃D₃ | S₂F₄D₃ | S₂T₃ |
| | S₂F₁D₄ | S₂F₂D₄ | S₂F₃D₄ | S₂F₄D₄ | S₂T₄ |
| Synthetic | S₃F₁D₁ | S₃F₂D₁ | S₃F₃D₁ | S₃F₄D₁ | S₃T₁ |
| Data 3 | S₃F₁D₂ | S₃F₂D₂ | S₃F₃D₂ | S₃F₄D₂ | S₃T₂ |
| | S₃F₁D₃ | S₃F₂D₃ | S₃F₃D₃ | S₃F₄D₃ | S₃T₃ |
| | S₃F₁D₄ | S₃F₂D₄ | S₃F₃D₄ | S₃F₄D₄ | S₃T₄ |

Post evaluation of the three phases (trained using same features, same test set) revealed that the highest error (1.43%) was obtained in Phase One, i.e., when the entire available history of price data for the stock for was used to train the model for that stock.

The next-lowest error (1.42%) was obtained in Phase Two, i.e., when only the most recent 600 days of price data for the stock for was used to train the model for that stock. Using only the most recent 600 days of price data ensured that the model did not get confused with older data.

The best performance, i.e., having the lowest error (1.35%), was obtained in Phase Three, i.e., when the model was trained using both (i) the most recent 600 days of price data from Phase Two and (ii) the synthetic data generated according to the methods disclosed and described with reference to FIGS. 1-9. Thus, training the models with a combination of actual data and synthetic data as in Phase Three was shown to have improved efficacy (as measured by the accuracy of the predicted stock prices) as compared to training the models with only actual data as in Phase One and Phase Two.

The performance of Phase Two using XGBoost improved by 0.70% with respect to the performance of Phase One. Phase Three experienced a further improvement of 0.49% as compared to Phase Two and 0.56% as compared to Phase One.

Since the average performance of stock price forecasting models that were trained with less data (600 days and the synthetic peer data) was better than the performance of the stock price forecasting models trained with more data (the entire history of data), the disclosed methods and processes are suitable for use in scenarios where less data (price or other data) is available which may occur in scenarios where the stock (or other security) is newer in the market or the nature of data used is sparse (e.g., fundamental information which comes out quarterly).

Thus, because traditional forecasting approaches typically rely on many years of historical data (often 10-15 years), these traditional approaches typically require a lot a of database storage when considering a large number of listed stocks such as the scenarios covered in Phases One, Two, and Three that considered the 500 stocks of the S&P 500. However, the disclosed approaches that use synthetic data in combination with actual data can use a shorter history of stock information (e.g., 2-3 years), which requires much less database storage than traditional approaches. As a result, the disclosed techniques improve the functioning and performance of the computing system(s) used for stock price forecasting since they (i) use less memory to store the data used for training stock price forecasting models as compared to traditional approaches and (ii) use less data overall to train the stock price forecasting models, thereby using fewer processing cycles and requiring a corresponding shorter amount of processing time as compared to traditional approaches.

The disclosed techniques can also be used in generation of synthetic information for other domains as well by adjusting the deviation (FLUX factor) with respect to domains.

### VII. Conclusions

In accordance with various embodiments of the present disclosure, one or more aspects of the methods described herein are intended for operation as software programs and/or components thereof running on one or more computer processors. Furthermore, software implementations can include, but are not limited to, distributed processing or component/object distributed processing, parallel processing, and/or virtual machine processing, any one of which (or combination thereof) can also be used to implement the methods described herein.

The present disclosure contemplates a tangible, non-transitory machine-readable medium containing instructions so that interconnected computing devices connected via communications networks can exchange voice, video and/or other data with each other in connection with executing the disclosed processes. The instructions may further be transmitted or received over one or more communications networks between and among computing devices.

While the machine-readable media may be shown in example embodiments as a single medium, the term “machine-readable medium” or “machine-readable media” should be taken to include a single medium or multiple media (e.g., a centralized or distributed database, and/or associated caches and servers) that store the one or more sets of instructions. The term “machine-readable medium” or “machine-readable media” shall also be taken to include any medium that is capable of storing, encoding or carrying a set of instructions for execution by the machine and that causes the machine to perform any one or more of the methodologies of the present disclosure.

The terms “machine-readable medium,” “machine-readable device,” or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium,” “machine-readable device,” or “computer-readable device” may be non-transitory, and, in certain embodiments, may not include a wave or signal per se. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure not be limited to the particular arrangement(s) disclosed as the best mode contemplated for carrying out this invention, but that the invention will include all embodiments and arrangements falling within the scope of the appended claims. The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

What is claimed is:

1. A method comprising:
receiving an actual dataset comprising a time-ordered sequence of actual historical price data of an actual security during a timeframe, wherein the actual security is listed on a financial exchange, and wherein the time-ordered sequence of actual historical price data comprises a market price of the actual security on the financial exchange at each time point of a plurality of time points during the timeframe;
based on the actual dataset, generating a plurality of synthetic datasets for a plurality of fictional securities during the timeframe, wherein each fictional security of the plurality of fictional securities is not listed on any financial exchange, wherein an individual synthetic dataset for an individual fictional security comprises a synthetic time-ordered sequence of historical price data for the fictional security, and wherein the time-ordered sequence of synthetic historical price data comprises a synthetic price of the fictional security at each time point of the plurality of time points during the timeframe; and
training a machine learning model with data comprising the actual dataset and the plurality of synthetic datasets, wherein after training the machine learning model, the machine learning model is configured to forecast a future price data of the actual security.

2. The method of claim 1, wherein generating a plurality of synthetic datasets for a plurality of fictional securities during the timeframe comprises, for an individual fictional security:
for each market price of the actual security at each time point of the plurality of time points during the timeframe, generating a synthetic price at the time point by multiplying the market price by a random number, wherein market prices at different time points are multiplied by different random numbers to generate the synthetic prices at the different time points; and
ordering the generated synthetic prices based on their corresponding time points into a synthetic dataset for the individual fictional security.

3. The method of claim 2, wherein the random number is within a range defined by a lower bound and an upper bound.

4. The method of claim 2, wherein generating a synthetic price at the time point by multiplying the market price by a random number comprises:
multiplying the market price by a random number that is less than 1, thereby resulting in a corresponding synthetic price that is lower than the market price at the time point.

5. The method of claim 2, wherein generating a synthetic price at the time point by multiplying the market price by a random number comprises:
multiplying the market price by a random number that is greater than 1, thereby resulting in a corresponding synthetic price that is higher than the market price at the time point.

6. The method of claim 2, wherein generating a synthetic price at the time point by multiplying the market price by a random number comprises:
generating a synthetic price at the time point by multiplying the market price by a first random number based on a second random number that is different than the first random number, wherein:
when the second random number has a first attribute, the first random number is less than one, thereby resulting in a corresponding synthetic price that is lower than the market price at the time point; and
when the second random number has a second attribute, the first random number is greater than one, thereby resulting in a corresponding synthetic price that is higher than the market price at the time point.

7. The method of claim 1, wherein training the machine learning model with data comprising the actual dataset and the plurality of synthetic datasets comprises:
for the actual security, extracting one or more features from price data in the actual dataset;
for the plurality of fictional securities, for each fictional security, extracting the one or more features from price data in the synthetic dataset for the fictional security; and
training the model to predict the future price of the actual security based at least in part on the one or more extracted features from the price data in the actual dataset and the one or more extracted features from the price data in each synthetic dataset.

8. The method of claim 7, wherein the one or more features, comprise one or more of: (i) a Relative Strength Index (RSI) that quantifies a speed and change of price movement of the price data, (ii) a Moving Average Convergence/Divergence (MACD) using two exponential moving averages of different timeframes to identify a strength of a directional move in the price data, (iii) an Average Direction Index (ADX) that measures a strength and momentum of change in the price data, (iv) a Stochastic Oscillator that measures a current price relative to a price range over a number of periods, (v) a Simple Moving Average (SMA) that measures an average price over a specific time period, or (vi) a Standard Deviation that measures volatility in the price data.

9. The method of claim 1, further comprising, after training the machine learning model with data comprising the actual dataset and the plurality of synthetic datasets:
predicting a future price for the actual security.

10. The method of claim 1, further comprising:
after training the machine learning model, receiving a subsequent actual dataset comprising a new time-ordered sequence of actual historical price data for the actual security during a subsequent timeframe, wherein the subsequent actual dataset includes market price data of the actual security on the financial exchange at each time point of a plurality of time points during the subsequent timeframe;
based on the subsequent actual dataset, generating a subsequent synthetic dataset for each fictional security during the subsequent timeframe, wherein an individual subsequent synthetic dataset for an individual fictional security comprises a time-ordered sequence of synthetic price data for the fictional security comprising a synthetic price of the fictional security at each time point of the plurality of time points during the subsequent timeframe;
generating an updated actual dataset by appending the subsequent actual dataset with at least a portion of the previously-received actual dataset;
generating a plurality of updated synthetic datasets by generating an updated synthetic dataset for each fictional security, wherein generating an updated synthetic dataset for an individual fictional security comprises appending the subsequent synthetic dataset for the fictional security with at least a portion of the previously-generated synthetic dataset for the fictional security; and
re-training the machine learning model on data comprising the updated actual dataset and the plurality of updated synthetic datasets, wherein after re-training, the machine learning model is configured to forecast future price data of the actual security.

11. The method of claim 1, wherein generating the plurality of synthetic datasets for the plurality of fictional securities during the timeframe comprises, for an individual synthetic dataset for an individual fictional security:
applying a bi-stage transformation to each data point sᵢ of the actual dataset to produce a corresponding synthetic data point pᵢ for the synthetic dataset, wherein the bi-stage transformation is defined by an equation pᵢ=(sᵢθᵢ) ψᵢsᵢ;
wherein θᵢ represents a maximum deviation percentage of pᵢ from sᵢ, and ψᵢ represents an associativity factor that determines a direction of deviation that is positive or negative.

12. The method of claim 11, further comprising:
selecting a value for θᵢ within a predetermined range of 0 to L, where L is a predefined maximum deviation limit, and θᵢ is a real number between 0 and L; and
setting ψᵢ to a positive or negative value, wherein (i) when ψᵢ is positive, synthetic price pᵢ is greater than or equal to actual price sᵢ, and (ii) when ψᵢ is negative, synthetic price pᵢ is less than or equal to actual price sᵢ.

13. The method of claim 1, wherein the actual security comprises one of (i) a stock, (ii) a bond, (iii) a derivative, or (iv) a market index.

14. Tangible, non-transitory computer-readable media comprising program instructions, wherein the program instructions, when executed by one or more processors, cause a computing system to perform functions comprising:
receiving an actual dataset comprising a time-ordered sequence of actual historical price data of an actual security during a timeframe, wherein the actual security is listed on a financial exchange, and wherein the time-ordered sequence of actual historical price data comprises a market price of the actual security on the financial exchange at each time point of a plurality of time points during the timeframe;
based on the actual dataset, generating a plurality of synthetic datasets for a plurality of fictional securities during the timeframe, wherein each fictional security of the plurality of fictional securities is not listed on any financial exchange, wherein an individual synthetic dataset for an individual fictional security comprises a synthetic time-ordered sequence of historical price data for the fictional security, and wherein the time-ordered sequence of synthetic historical price data comprises a synthetic price of the fictional security at each time point of the plurality of time points during the timeframe; and
training a machine learning model with data comprising the actual dataset and the plurality of synthetic datasets, wherein after training the machine learning model, the machine learning model is configured to forecast a future price data of the actual security.

15. The tangible, non-transitory computer-readable media of claim 14, wherein generating a plurality of synthetic datasets for a plurality of fictional securities during the timeframe comprises, for an individual fictional security:
for each market price of the actual security at each time point of the plurality of time points during the timeframe, generating a synthetic price at the time point by multiplying the market price by a random number, wherein market prices at different time points are multiplied by different random numbers to generate the synthetic prices at the different time points; and
ordering the generated synthetic prices based on their corresponding time points into a synthetic dataset for the individual fictional security.

16. The tangible, non-transitory computer-readable media of claim 15, wherein the random number is within a range defined by a lower bound and an upper bound, and wherein generating a synthetic price at the time point by multiplying the market price by a random number comprises at least one of (i) multiplying the market price by a random number that is less than 1, thereby resulting in a corresponding synthetic price that is lower than the market price at the time point, or (ii) multiplying the market price by a random number that is greater than 1, thereby resulting in a corresponding synthetic price that is higher than the market price at the time point.

17. The tangible, non-transitory computer-readable media of claim 14, wherein training the machine learning model with data comprising the actual dataset and the plurality of synthetic datasets comprises:
for the actual security, extracting one or more features from price data in the actual dataset;
for the plurality of fictional securities, for each fictional security, extracting the one or more features from price data in the synthetic dataset for the fictional security;
training the model to predict the future price of the actual security based at least in part on the one or more extracted features from the price data in the actual dataset and the one or more extracted features from the price data in each synthetic dataset.

18. The tangible, non-transitory computer-readable media of claim 17, wherein the one or more features comprise one or more of: (i) a Relative Strength Index (RSI) that quantifies a speed and change of price movement of the price data, (ii) a Moving Average Convergence/Divergence (MACD) using two exponential moving averages of different timeframes to identify a strength of a directional move in the price data, (iii) an Average Direction Index (ADX) that measures a strength and momentum of change in the price data, (iv) a Stochastic Oscillator that measures a current price relative to a price range over a number of periods, (v) a Simple Moving Average (SMA) that measures an average price over a specific time period, or (vi) a Standard Deviation that measures volatility in the price data.

19. The tangible, non-transitory computer-readable media of claim 14, further comprising, after training the machine learning model with data comprising the actual dataset and the plurality of synthetic datasets:
predicting a future price for the actual security, wherein the actual security comprises one of (i) a stock, (ii) a bond, (iii) a derivative, or (iv) a market index.

20. The tangible, non-transitory computer-readable media of claim 14, further comprising:
after training the machine learning model, receiving a subsequent actual dataset comprising a new time-ordered sequence of actual historical price data for the actual security during a subsequent timeframe, wherein the subsequent actual dataset includes market price data of the actual security on the financial exchange at each time point of a plurality of time points during the subsequent timeframe;
based on the subsequent actual dataset, generating a subsequent synthetic dataset for each fictional security during the subsequent timeframe, wherein an individual subsequent synthetic dataset for an individual fictional security comprises a time-ordered sequence of synthetic price data for the fictional security comprising a synthetic price of the fictional security at each time point of the plurality of time points during the subsequent timeframe;
generating an updated actual dataset by appending the subsequent actual dataset with at least a portion of the previously-received actual dataset;
generating a plurality of updated synthetic datasets by generating an updated synthetic dataset for each fictional security, wherein generating an updated synthetic dataset for an individual fictional security comprises appending the subsequent synthetic dataset for the fictional security with at least a portion of the previously-generated synthetic dataset for the fictional security; and
re-training the machine learning model on data comprising the updated actual dataset and the plurality of updated synthetic datasets, wherein after re-training, the machine learning model is configured to forecast future price data of the actual security.
